(19) United States
(12) Patent Application Publication
(10) Pub. No.: US 2004/0044094 A1
(43) Pub. Date: Mar. 4, 2004

(54) Radiation polymerisable compositions having accelerated cure

(76) Inventor: John Lyndon Garnett, Neutral Bay (AU)

Correspondence Address: ANDREW N. PARFOMAK, Norris McLaughlin and Marcus, P.A., 30th Floor, 220 E. 42nd Street, New York, NY, 10128, US

(21) Appl. No.: 10/379,623

(22) Filed: Mar. 5, 2003

(30) Foreign Application Priority Data
Sep. 5, 2000 (AU) PQ 9902
Sep. 5, 2000 (AU) PQ 9903

(51) Int. Cl. C08J 7/18; C08G 2/00

(52) U.S. Cl. 522/1; 427/487

(57) ABSTRACT

A radiation polymerisable composition comprising: (A) a donor/acceptor component for forming a charge transfer complex said component being selected from the group consisting of: (i) a bifunctional compound having an electron donor group and an electron withdrawing group and a polymerisable unsaturated group; (ii) a mixture of (a) at least one unsaturated compound having an electron donor group and a polymerisable unsaturated moiety; and (b) at least one unsaturated compound having an electron acceptor group and a polymerisable unsaturated group; and (B) a Lewis acid.

### TECHNICAL FIELD

The present invention relates to radiation polymerisable compositions and in particular to compositions curable with ultraviolet light (UV) or electron beam (EB) radiation or elemental sources such as cobalt with its gamma rays, strontium 90 or caesium 137 and the like.

### BACKGROUND

Radiation polymerisable compositions are used in a range of applications including coatings, inks, films, composites and interpenetrating polymer networks (IPN's). Radiation polymerisable compositions typically contain acrylate or methacrylate monomer and a prepolymer and when UV curing is to be used a photoinitiator or photosensitiser is required.

Attempts have been made to increase curing efficiency and reduce the need to use photoinitiators by increasing the sensitivity of compositions however in many cases this reduces their stability and also reduces the options available to the end user.

Pigmented radiation curable systems have previously been predominantly associated with inks, particularly with UV (reference Pappas, S. P. in. UV-Curing: Science and Technology. Vols. II, Pappas (Ed.), Technol, Mark, Corp.: Norwalk, 1985, Rad Tech Meetings like RadTech North America, RadTech Europe and RadTech Asia). Such inks usually require large concentration of photoinitiator(s) (PI) to cure efficiently especially with colours, particularly black.

The present applicants have been granted patents in Australia and USA for radiation curable pigmented systems. These systems are disclosed, for example, in U.S. Pat. No. 6,162,511. These patents are based on monomer/oligomer polymer systems which are typically acrylates. One of the concepts involved in these patents is the heating of the paint which is applied at temperatures above ambient to improve application. The technique enables a paint or clear coating, even matte finish, to be applied by spray, curtain coat or related techniques.

### SUMMARY OF INVENTION

We have now found, pursuant to the present invention, that polymerisation is accelerated by using a charge transfer complex in the presence of a Lewis acid. The compositions and processes of the present invention may be used for both pigmented and non-pigmented applications.

The present invention accordingly provides a radiation polymerisable composition comprising:

(A) a donor/acceptor component for forming a charge transfer complex said component being selected from the group consisting of:

(i) a bifunctional compound having an electron donor group and an electron withdrawing group and a polymerisable unsaturated group; and

(ii) a mixture of (a) at least one unsaturated compound having an electron donor group and a polymerisable unsaturated moiety; and (b) at least one unsaturated compound having an electron acceptor group and a polymerisable unsaturated group; and

(B) a Lewis acid.

The invention further provides a process for forming a coating on a substrate comprising providing a polymerisable composition comprising:

(A) a donor/acceptor component for forming a charge transfer complex said component being selected from the group consisting of:

(i) a bifunctional compound having an electron donor group and an electron withdrawing group and a polymerisable unsaturated group;

(ii) a mixture of (a) at least one unsaturated compound having an electron donor group and a polymerisable unsaturated moiety; and (b) at least one unsaturated compound having an electron acceptor group and a polymerisable unsaturated group; and

(B) a Lewis acid;

applying a coating of the composition to the substrate and subjecting the coating to radiation for sufficient time to cure the coating.

The Lewis acids acts as accelerator in the presence of the charge transfer complex. The composition can therefore be cured more rapidly than is possible in the corresponding composition without the Lewis acid. Further in many cases the invention allows compositions containing charge transfer complexes which could only be cured with difficulty and hence are not commercially useful, to be used in an efficient curing system.

The present invention requires the use of a Lewis acid which may be classified as hard, soft or borderline Lewis acid using the Pearson classification of Lewis acids. Lewis acids also include protic acids such as mineral and organic acids

The preferred Lewis acids are borderline and hard Lewis acids. Borderline Lewis acids are particularly preferred.

Examples of Lewis acids are shown in the following table:

| Hard | Borderline | Soft |
|---|---|---|
| H⁺ Li⁺ Na⁺ K⁺ Be²⁺ | Fe²⁺ Co²⁺ Ni²⁺ | Cu⁺ Ag⁺ Au⁺ TI⁺ Hg⁺ |
| Mg²⁺ Ca²⁺ Sr²⁺ Mn²⁺ | Cu²⁺ Zn²⁺ Pb²⁺ | Pd²⁺ Cd²⁺ Pl²⁺ Hg²⁺ |
| Al³⁺ Sc³⁺ Ga³⁺ In³⁺ La³⁺ | Sn²⁺ Sb³⁺ SO₂ | CH₃Hg⁺ Pt⁴⁺ Te⁴⁺ TI³⁺ |
| N³⁺ Cl³⁺ Gd³⁺ Lu³⁺ Cr³⁺ | Ir³⁺ Bi³⁺ Rh³⁺ | TI(CH₃)₃ BH₃ Ga(CH₃)₃ |
| Co³⁺ Fe³⁺ As³⁺ CH₃Sn³⁺ | NO⁺ Ru²⁺ Os²⁺ | GaCl₃ Gal₃ InCl₃ |
| Si⁴⁺ Ti⁴⁺ Zr⁴⁺ Th⁴⁺ U⁴⁺ | B(CH₃)₃ GaH₃ | RS⁺ RSe⁺ RTe⁺ |
| Pu⁴⁺ Ce³⁺ Hf⁴⁺ Sn⁴⁺ | R₃C⁺ C₆H₅⁺ | I⁺ Br⁺ HO⁺ RO⁺ |
| UO²⁺ VO²⁺ WO⁴⁺ MnO³⁺ | | 1₂ Br₂ ICN etc. |
| (CH₃)₂Sn²⁺ Be(CH₃)₂ BF₃ | | Trinitrobenzene etc. |
| B(OR)₃ Al(CH₃)₃ AlCl₃ | | Chloranil, Quinones etc. |
| AlH₃ RPO₂⁺ SO₃ RCO⁺ | | Tetracyanoethylene etc. |
| I⁷⁺ I⁵⁺ Cl⁷⁺ Cr⁶⁺ CO₂ N⁺ | | O Cl Br I N RO RO₂ |
| HX (hydrogen bonding | | M° (metal atoms) Bulk |
| molecules) | | metals |
| | | CH₂ carbenes |

The Lewis acid may be a protic acid. Examples of protic Lewis acids include: hydrogen halides such as HCl, HF and HBr particularly HCl; sulphuric acid; sulphonic acids such as p-toluenesulphonic acid; phosphonic acids, substituted phosphonic acids, phosphoric acid, nitric acid, phenols, substituted phenols, aromatic carboxylic acids, substituted aromatic carboxylic acids, hydroxy substituted aromatic carboxylic acids, carboxylic acids such as optionally substituted C₁ to C₈ carboxylic acids and mixtures of two or more thereof.

The preferred salt type Lewis acids are selected from borderline Lewis acids and magnesium. The most preferred Lewis acids of this type are halides of zinc, tin, antimony, iron, copper, magnesium, manganese and cobalt.

The preferred carboxylic acids such as C₁ to C₈ carboxylic acid, are C₁ to C₈ unsaturated carboxylic acids. The most preferred examples of carboxylic acids include formic acid, acetic acids, acrylic acid, methacrylic acid, itaconic, oxalic acid and icosic acid and citric acid. Polycarboxylic acids such as citric acid, oxalic acid, succinic acid, maleic acid and EDTA may also be used.

The Lewis acid may need only be used in catalytic amounts. Typically the amount of Lewis acid will be less than 0.5 mole per mole of molar double bonds of the charge transfer complex. More preferably the molar ratio of Lewis acid is in the range of from 0.0005 to 0.1 and even more preferably 0.005 to 0.05 based on a number of moles of double bonds in the charge transfer complex.

In one aspect the donor/acceptor component is an unsaturated compound that contains both the electron donor group and the electron withdrawing group. Preferably the charge transfer complex is obtained from at least one unsaturated compound that has an electron donor group and at least another unsaturated compound that has an electron withdrawing group. The compounds employed to provide the charge transfer complex can be ethylenically unsaturated or acetylenically unsaturated. When the complex is formed from two or more compounds, typically, the double bond molar ratio of the electron donating compound to the electron withdrawing compound is about 0.5 to about 2, and more typically about 0.8 to about 1.2 and preferably about 1 to 1.

In one embodiment, the compositions of the invention do not spontaneously polymerise under ambient conditions. The strength of both the donor and acceptor groups and their interaction with the Lewis acid are less than required to spontaneously polymerise. Instead they polymerise under the influence of the necessary ultraviolet light or ionising radiation. Alternatively where compositions are more labile they may be formed immediately prior to application and irradiation. For example the Lewis acid may be combined with the other components immediately prior to irradiation to provide an increased rate of cure.

The charge transfer complex formed from the donor/acceptor is capable of absorbing light having a wave-length that is longer than the longest wavelength in the spectrum of light absorbed by the individual donor and withdrawing groups used to form said complex. The ultraviolet light is thus absorbed by the charge transfer complex rather than by individual groups or components forming said complex. This difference in absorptivity is sufficient to permit the polymerisation of said complex to proceed by absorbing light.

In the terms of commercial utilisation, the complex typically absorbs light which has a wavelength that is about 10-nanometers longer than the shortest wavelength in the spectrum of light absorbed by the individual donor and withdrawing groups or components. This facilitates tailoring the spectral output from the ultraviolet light source to assure the desired polymerisation.

The complex should, on initial exposure to UV, lead to radicals which can initiate free radical polymerisation. In addition to UV, the polymerisation can also be achieved by the use of ionising radiation such as gamma rays or electrons from an electron beam machine. This process can be achieved to workable radiation doses and in air.

The electron withdrawing and electron donating compounds can be represented by the following formula:

(A)ₙ—R and (D)ₙ—R, respectively;

wherein “n” is an integer preferably from 1 to 4, “R” is the structural part of the backbone. “A” is the structural fragment imparting acceptor properties to the double bond.

This is selected from the groups outlined in the Jonsson et al (U.S. Pat. No. 5,446,073) and consists of maleic diesters, maleic amide half esters, maleic diamides, maleimides, maleic acid half esters, maleic acid half amides, fumaric acid diesters and monoesters, fumaric diamides, fumaric acid monoesters, fumaric acid monoamides, exomethylene derivatives, itaconic acid derivatives, nitrile derivatives of preceding base resins and the corresponding nitrile and imide derivatives of the previous base resins particularly maleic acid and fumaric acid.

Typical compounds having an electron acceptor group and a polymerisable unsaturated group are maleic anhydride, maleamide, N-methyl maleamide, N-ethyl maleamide, N-phenyl maleamide, dimethyl maleate, diethyl maleate, diethyl and dimethyl fumarate, adamantane fumarate and fumaric dinitrile. Analogous maleimide, N-methyl maleimide, N-ethyl maleimide, phenyl maleimide and their derivatives can also be used.

Due to the presence of Lewis acids, monomers with weak electron acceptor groups can be effectively utilized. Examples of such monomers include monomers with either pendant carbonyl or cyano groups. These can be used as acceptors since in the presence of the Lewis acid, these monomers complex and increase the difference in polarity with donor monomers. Such additional acceptor monomers include acrylonitrile and derivatives, acrylic acid and derivatives, acrylamide and derivatives, acrylates and methacrylates and derivatives, especially the lower molecular weight compounds like methyl acrylate and methylmethacrylate also methyl vinyl ketone and derivatives.

Polyfunctional compounds, that is polyunsaturated compounds including those with 2, 3, 4 and even more unsaturated groups, can like wise be employed and in fact are to be preferred. The examples include polyethylenically unsaturated polyesters, for example polyesters from fumaric or maleic acids and anhydrides thereof.

“D” is the structural fragment imparting donor properties to the double bond. Examples of component D are provided in the Jonsson et al U.S. Pat. No. 5,446,073 and includes vinyl ethers, alkenyl ethers, substituted cyclopentanes, substituted cyclohexanes, substituted furanes or thiophenes, substituted pyrans and thiopyrans, ring substituted styrenes, substituted alkenyl benzenes, substituted alkenyl cydopentanes and cyclohexenes. In the styrene systems, substituents in the ortho- and para-positions are preferred. Unsaturated vinyl esters like vinyl acetate and its derivatives can also be used.

In addition, polyfunctional, that is, polyunsaturated compounds including those with two, three, four or even more unsaturated groups can likewise be employed.

With respect to the ethers, mono-vinyl ethers and di-vinyl ethers are especially preferred. Examples of monovinyl ethers include alkylvinyl ethers typically having a chain length of 1 to 22 carbon atoms. Di-vinyl ethers include di-vinyl ethers of polyols having for example 2 to 6 hydroxyl groups including ethylene glycol, propylene glycol, butylene glycol, 3 methyl propane triol and pentaerythritol.

Examples of some specific electron donating materials are monobutyl 4-vinylbutoxy carbonate, monophenyl-4-vinylbutoxy carbonate, ethyl vinyl diethylene glycol, p-methoxy styrene, 3,4-dimethoxypropenylbenzene, N-propenylcarbazole, monobutyl-4-propenylbutoxycarbonate, monophenyl-4-propenylbutoxycarbonate, isoeugenol and 4-propenylanisole. Vinyl acetate is also active especially with monomers like maleic anhydride and the maleates. N-vinyl pyrollidone, vinyl pyridines, vinyl carbazole, and styrene can also be used in certain applications as donors.

Typical bifunctional compounds containing both acceptor or withdrawing groups and a donor group can be used and are listed in the Jonsson et al patent. Examples of suitable bifunctional compounds include those made from condensing maleic anhydride with 4-hydroxybutyl vinyl ether and the like.

A further limitation of the donor/acceptor composition disclosed in Jonsson is the relative expense of many donor/acceptor components relative to the UV curable monomers currently used in industry. Among the less expensive acceptor components is maleic anhydride (MA) which can be combined with a donor, which may be a vinyl ether such as triethylene glycol di-vinyl ether, to provide a cured film.

A further aspect of the invention is the use of unsaturated polyesters as a predominant component in these formulations. One of the most preferred polyesters is defined later and is a Nuplex Australia P/L product.

In the present invention such polymers, like the Nuplex polyester when dissolved in monomers, even styrene, have been shown to cure very slowly with UV and are currently commercially viable only with difficulty. When the CT complexes are added to the polyester as additives, the resulting resin mixture cures well especially with excimer sources. Polystyrene can also be used to replace the polyester in these formulations.

Under certain circumstances with conventional UV systems, photoinitiators (PI) may be needed, however many UV sources can achieve cure without PI. Without these CT additives the polyester system is unsuitable for UV commercial curing. This separate aspect of the invention thus Involves the use of the CT complexes already discussed as additives to accelerate the polyester cure. The addition of Lewis acids in these systems accelerate the process considerably.

The activating effect of the Lewis acid catalyst is such that it enables donor acceptor complexes to be used which would not otherwise be of practical use due to their slow rate of polymerisation or the energy required for activation. Oligomers such as vinyl ether capped oligomers and malonate capped oligomers may be used. In general, vinyl ether functionailised compounds of relevance include those derived from urethanes, phenols, esters, ethers, siloxanes, carbonates and aliphatic or aromatic hydrocarbons. Specific examples of vinyl ether capped oligomers include the “Vectomer 1312” brand of vinyl ether capped urethane oligomer available from Allied Signal, U.S.A.

The invention generally allows coatings to be formed using the current commercial lamp systems with donor/acceptor charge transfer complexes described above, otherwise the addition and installation of more efficient lamps becomes very expensive and limits the application of the process. Newly developed excimer sources such as the Fusion V.I.P. system will cure most of the systems discussed. These V.I.P. systems are expensive and their ready availability is required, however there are currently few V.I.P. commercial facilities on stream. The present CT system in the Jonsson et al patent possesses a number of limitations in practical use even with the V.I.P. lamp system. Thus MA, although the cheapest of available donors, suffers from the disadvantage of solubility when used with the less expensive donors like DVE-3. This problem causes the MA to crystallise out of solution when the DA mixture is at temperatures of 25° C. or lower, i.e. common room temperature. Thus storage and transit become a problem under these conditions and the mixture to be used must be reheated carefully before application to redissolve the MA. This heating operation can give rise to significant dangers since the CT complex is very temperature sensitive and can exothermically explode if the heating is not performed carefully. This heating operation would be difficult in commercial environments. In addition, at the time of application, the mixture needs to be at temperatures above 25° C. otherwise coating is a problem and so the line and the mixture need to be continuously heated for application. MA has another disadvantage in this work due to its volatility and odour, which is unacceptable for certain applications at the level of MA used. The problem is not confined to the DVE-3 complex. The other ethers behave in a similar manner and are more expensive than DVE-3.

Of the available acceptors other than maleates, the maleimides are the most reactive such as the alkyl derivatives such as N-hexyl maleimide, The problem with the maleimides is their toxicity and thus extreme caution must be exercised in commercial situations with such materials. Their use is not therefore favoured industrially.

A problem also exists with the most economically available donors such as DVE-3. These materials have very low viscosity which can render the final coating formulations unsatisfactory for many commercial applications since the coatings can either run off or be absorbed by the substrate. We have found that the viscosities of such formulations need to be increased significantly before the coatings are suitable for industrial use.

The donor/acceptor component preferably has a relatively low molecular weight, typically of no more than 5000 and more preferably of no more than about 1100 and has a high proportion of unsaturation to readily form donor accepter charge transfer complexes.

The composition of the invention may additionally include a binder polymer which may have a significantly higher molecular weight and low level of residual unsaturation. For example when used the molecular weight of a binder polymer is typically higher than 1100, preferably greater than 2000 or a highly viscous material and most preferably greater than 5000. A binder polymer is typically a solid or a highly viscous material at room temperature though in use in the composition of the invention it will typically be dissolved in the other components. A binder polymer preferably will not readily complex with donors such as triethylene glycol divinyl ether (DVE-3) or acceptor to provide a cured film on its own in the absence of a donor/acceptor complex.

Suitable donor/acceptor complexes for use in the present invention are disclosed in U.S. Pat. No. 5,446,073 by Jonsson et al. In the absence of Lewis acid catalysts or binders their use generally requires newly developed excimer sources which are not commonly used in current industrial UV curing systems. The compositions of the invention by contrast allow rapid cure and yet allow their use to be controlled to provide useful industrial application in many cases allowing UV curing in the absence of photoinitiators and yet are relatively inexpensive.

Binder polymers may be used to improve the cure speed particularly of MA/DVE-3 and similar complexes and to improve the stability of the complexes prior to cure. A further advantage of such binder polymers is that they reduce significantly the odour of MA/DVE-3 complex and related complexes.

The weight ratio of donor/acceptor complex to said binder polymer is typically in the range of 1:99 to 95:5 with from 30:70 to 70:30 being preferred and 60:40 to 40:60 being most preferred.

In a further preferred embodiment the acceptor comprises a mixture of maleic anhydride and an ester selected from the group consisting of the mono- and di-methyl and ethyl maleic esters. While the weight ratio of ester to MA can be up to 99:1 we have found that the best rate of cure is provided if the ratio of ester to MA is less than 75:25 and more preferably 75:25 to 25:75. Most preferably a diester is used and the ratio of diester to MA is in the range of 60:40 to 40:60.

The use of the binder polymer may also give stability to compositions such as maleic anhydride and increases viscosity of composition. A particular advantage is the improved solubility of the acceptor component particularly maleic anhydride and the donor particular ethers including vinyl ethers such as triethylene glycoldivinylether (DVE-3). The presence of the binder also leads to improved complex stability at a range of temperatures especially room temperature at which most applications occur.

The preferred binder polymers are selected from unsaturated polyesters, vinyl ethers, polystyrene polyarylamides, polyvinyl acetate, polyvinyl pyrrolidones, acrylonitrile butadiene styrene, cellulose derivatives and mixtures thereof.

Polyesters and polyvinyl ethers are preferred and most preferred are alkyd polyesters prepared from copolymers of a polyol such as alkylene glycol or polyalkylene glyol and anhydride such as maleic anhydride phthalic anhydride or mixture thereof. One specific example of the preferred polyester alkyd is available from Orica Ltd Australia and is prepared from propylene glycol, phthalic anhydride and maleic anhydride. Particularly preferred polymers are vinyl ether capped oligomers and malonate capped oligomers as discussed hereinbefore. The oligomer position may be a urethane oligomer. An example of the preferred vinyl ether polymer is Vectomer 1312 brand vinyl ether polymer of Allied Signal, USA.

If photoinitiators are used for example in highly pigmented systems, suitable examples of photoinitiators may include benzoin ethers such as α,α-dimethoxy-2-phenylacetophenone (DMPA); α,α-diethoxy acetophenone; α-hydroxy-α,α-dialkyl acetophenones such as α-hydroxy-α,α-dimethyl acetophenone and 1-benzoylcyclohexanol; acyl phosphine oxides such as 2,4,6-trimethylbenzolyl diphenyl phosphine oxide and bis-(2,6-dimethoxybenzoyl)-2,4,4-trimethylphenylphosphine; cyclic photoinitiators such as cyclic benzoic methyl esters and benzil ketals; cyclic benzils; intermolecular hydrogen abstraction photoinitiators such as benzophenone, Michlers ketone, thioxanthones, benzil and quinones; and 3 ketocoumarins. Typical of such photoinitiators are the Ciba Geigy range of Irgacure 819, 1800, 1700 and the like, also Darocure 1173.

In the case of clear coatings a photoinitiator may not be necessary or may be used in minor amounts of up to 2% if desired. Pigmented systems may use a photoinitiator with the amount required depending on the level of pigmentation. Amounts of PI may be up to 6% by weight, this is typical for the most difficult of pigmented systems such as black inks and coatings and the like.

The photoinitiator component may also be used in combination with an amine coinitiator particularly a tertiary amine coinitiator. This is particularly preferred in the case of the intermolecular hydrogen abstraction photoinitiators such as benzophenone. The amine is generally triethanolamine or an unsaturated tertiary amine such as dimethylaminoacrylate, diethylaminoethylacrylate or the corresponding methacrylates. An amine/acrylate adduct such as that sold under the trade name Uvecryl 115 by Tollchem Pty Ltd Australia is also useful as a coinitiator. Where the unsaturated amine is used it will of course contribute to the monomer or polymer component. If the latter components are used as PI, care must be exercised in formulation to show that the components of the original CT complex do not interfere and slow the cure.

Oligomer acrylates such as epoxy acrylate, urethane acrylate polyether acrylate and polyester acrylate may be used if desired. In addition acrylate monomers may also be used as additives especially the multifunctional acrylates like tripropylene glycol diacrylate (TPGDA) which improve cross linking and are also used to speed up cure of oligomer acrylates and UV cure.

Such materials are supplied by Sartomer, UCB and the like. Again, if the acrylate monomers are incorporated PI may be needed to achieve cure. The level of PI may be of the order of at least 1% by weight of total polymer.

Finally mixtures of acrylate oligomer with acrylate monomer (e.g. TPGDA) may also be used in combination instead of either, separately. Again in this instance PI may be needed at the levels previously mentioned for oligomer acrylate and acrylate monomer when used individually.

In addition to its application in the curing of inks and coatings, both clear and pigmented, on to various substrates, the present invention can also be used to modify the surface properties of substrates by radiation grafting reactions. Both UV and ionising radiation can be used to initiate these processes. Under some circumstances, UV may require the incorporation of low concentrations of PI's. In many systems this will not be necessary. The grafting process may involve the reaction of small amounts of DA copolymer (<1%) or it may use extremely large amounts (˜1000%). In the former case when small amounts of DA complex are grafted on to the substrate, surface properties are essentially affected whereas in the latter case where large amounts are grafted, the substrate effectively acts as a template for a new product formation in a sandwich like fashion.

In addition to grafting and curing, the present invention is applicable to the homopolymerisation of DA complexes, with and without diluents such as other monomers like acrylates and styrene, in bulk to yield homocopolymers with applications in a wide range of fields. Again additions of small amounts of Lewis acids can lead to rapid polymerisation in bulk when the DA complex is exposed to appropriate radiation (UV or ionising radiation). In many examples without the use of Lewis acid additions, the reaction doesn't proceed with radiation or proceeds too slowly for efficient industrial processing.

A further aspect of the present invention involves a method for improving the adhesion of the above cured inks and coatings on substrates where it is difficult to achieve strong bonding i.e. even with various types of tape tests the coating can be removed. The technique used here is to expose the substrate to either corona discharge, UV or ionising radiation prior to coating. This method may be used on relatively inert substrates such as plastics including polyolefins or more polar substrates such as paper cardboard or the like.

Examples of ethylenically unsaturated monomers that can be used include unsaturated carboxylic acids and esters particularly acrylate and methacrylate esters.

Acrylamides, allyl compounds such as diallyl phthalate, maleimide and its derivatives; maleic acid, maleic anhydride, fumaric acid, and their esters and amides, and other unsaturated compounds such as benzene, di-vinyl benzene, N-vinylcarbazole and N-vinylpyrrolidone.

The preferred monomers are monomers comprising a plurality of acrylate or methacrylate functional groups which may be formed, for example, from polyols or the like. Examples of such multifunctional acrylates include trimethylolpropane triacrylate (TMPTA) and its ethoxylated derivative, neopentyl glyol diacrylate, tripropyleneglycol diacrylate (TPGDA), hexanediol diacrylate (HDDA) and polyethyleneglycol diacrylates such as that formed from PEG 200. The molecular weight of the monomer will typically be less than 2000.

The composition used in the method of the invention may include a thermal polymerisation inhibitor such as di-t-butyl-p-cresol, hydroquinone, benzoquinone or their derivatives and the like. Di-t-butyl-p-cresol is preferred. The amount of thermal polymerisation inhibitor is typically up to 10 parts by weight relative to 100 parts by weight of the resin component.

The composition may contain an ultraviolet light stabiliser which may be a UV absorber or a hindered amine light stabiliser (HALS). Examples of UV absorbers include the benzotriaziols and hydroxybenzophenones. The most preferred UV stabilisers are the HALS such as bis(1,2,2,6,6-pentamethyl-4-piperidyl) sebacate which is available from Ciba as TINUVIN 292 and a poly[6-1,-1,3,3-tetramethylbutyl)imino-1,3,5-triazin-2,4-diyl][2,2,6,6-tetramethyl-4-piperidyl)imino]hexamethylene [2,2,6,6-tetramethyl-4-piperidyl)imino] available from Ciba under the brand name TINUVIN 770. The amount of UV stabiliser that is effective will depend on the specific compounds chosen but typically up to 20 parts by weight relative to 100 parts by weight of resin component will be sufficient.

The UV stabiliser may be used simply to provide UV protection to the coating applied in accordance with the invention in which case up to 10 parts by weight will generally be adequate and in the case of HALS 0.05 to 5 parts is preferred. In some embodiments however it may be desirable to use a high concentration of stabiliser particularly where UV protection is also to be provided for the substrate to which the coating is to be applied.

If flame retardency is desired the composition used in the process of the invention may include one or more flame retarding additives. Preferred examples of such additives may be selected from the following:

a: “FYROL 76” *(with and without free radical catalyst such as tertiary butyl hydroperoxide, cumene peroxide or ammonium persulphate);

b: “FYROL 51”*

c: “FYROL 6”*and/or “FYROL 66” *with and without catalyst;

PRODUCTS OF AKZO CHEMICALS LTD.;

d: “PE-100” and “W-2” (EASTERN COLOR CHEMICALS P/L) of the USA;

e: “PROBAN” *with and without catalyst such as ammonia or an amine;

*an ALBRIGHT AND WILSON Aust. PTY LTD. PRODUCT;

f: “PYROVATEX” *with and without catalyst;

*a CIBA GEIGY Aust. PTY LTD. PRODUCT;

g: “PYROSET” *“TPO” and “TKOW” with and without catalyst;

*PRODUCTS OF CYANAMID Aust. PTY. LTD.;

h: simple phosphates such as mono, di, and triammonium ortho phosphates and their alkali metal equivalents;

i: alkali metal and ammonium sulphamates;

j: alkali metal and ammonium range of poly phosphates;

k: ammonium sulphates;

l: alkali metal and ammonium chromates and dichromates;

m: alkali metal carbonates;

n: alkali metal tungstate;

o: boric acid and borax;

p: organo phosphorus or organo boron compounds;

and mixtures of two or more of the above.

The preferred amount for each system may be determined by experiment. When the additives are used with the resin, the finished product may be fire retarded in accordance with Australian Standard AS1530 Parts 2 and 3.

Particularly preferred fire retarding additives are Fyrol 76, Fyrol 51, PE-100 and W-2 and mixtures thereof. The other flame retardants in “a” to “p” are best used for specific applications and as with all the above retarding additions, their conditions of use are determined by the equivalent level of phosphorus present in the finish. When the Fyrols or PE-100 or W-2 are used, the amounts are 1 to 50% based on the mass of resin solids with 2 to 20% preferred. Generally, the equivalent proportion of elemental phosphorus (and boron if used in combination) in the combination to a level of 4.0% P is needed to achieve the required flame retardency. However, significantly less may be needed depending on the substrate material. For example some materials may need only 2.0% P. In such cases the exact levels of phosphorus containing compound required are determined exactly by experiment. Thus the range covered from 0.02 to 15% of elemental phosphorus based on the mass of the substrate material to be treated may be used, with 0.2 to 4.0% P being the preferred range to achieve flame retardency. Flame retardants are particularly useful where the coating is to be applied to a textile or natural or synthetic fibre.

We have also found that superior coating properties are provided when the coating is applied to a wet substrate.

Additional additives which may be used in the formulations are wetting agents, water if required, matting agents, solvents if required, fluorinated additives and silanes to improve gloss and flow, surfactants, levelling agents, fillers, pigments, slip agents and defoaming agent.

A further aspect of the current invention is the ability to reduce the gloss of the clear coating to give either a matt or semi gloss UV cured finish. This is accomplished by adding to a 1:1:2 mol. ratio mixture of MA, DVE-3, PE 4% calcium carbonate and 4% of pyrogenic silica (Acermatt OK 412, De Gussa) with 4% Irgacure 819 to give a semi gloss W finish. If the calcium carbonate is increased to 6% and the Irgacure 819 to 8% a matt UV cured finish is achieved.

The invention further provides a process for preparing a radiation curable composition comprising forming a mixture of:

(a) at least one unsaturated compound having an electron donor group and a polymerisable unsaturated moiety;

(b) at least one unsaturated compound having an electron acceptor group; and

(c) a Lewis acid.

The process may further include addition of one or more further components such as the photoinitiator, monomer, pigment and flame retarders in accordance with respective components described above.

The invention will now be described with reference to the following examples. It is to be understood that the examples are provided by way of illustration of the invention and that they are in no way limiting to the scope of the invention.

The invention may be used to coat a range of materials including polymeric materials, cementitious, metallic and cellulosic materials. The compositions of the invention may also be used to form composites by including fibrous components such as natural, polymeric or material fibres. Fibrous material may be incorporated into the composition or the substrate may be overlayed with fibrous material such as fibreglass before application and curing of the composition of the invention to form a composite. Composites of this type are useful in forming complex shapes such as in boat building. The compositions of the invention are particularly useful in coating polystyrene and in one embodiment are used to coat a polystyrene shaped article.

In one specific embodiment, coatings of the invention are applied to a pallet of the type used for support and transport of goods. The pallet may be formed of polystyrene or other suitable material optionally using a fibrous reinforcement before application and curing of the coating composition.

### EXAMPLES

Examples of the above concepts are shown in Tables 1-3. These data show the acceleration effect of Lewis acids compared with Pi in gelling of typical CT complex formulations in bulk. This information is important in the use of this technique for composite work and IPN processes. Examples of the use of a Lewis protic and are also given. The Lewis acids used to accelerate these reactions are Lewis acids such as SbCl₃, SbCl₅, ZnCl₂, FeCl₂, FeCl₃, SnCl₂, SnCl₄, CuCl₂, MgCl₂, MnCl₂, CoCl₂, CoCl₃, and the like. Theoretically any anion is capable of being used, the halogens are preferred with the chlorides being most preferred because of suitable solubility properties and the like. In UV work they can be used with photoinitiators (PI) to give an accelerating effect or they can be used alone. No PI's are needed with ionising radiation work. Currently SbCl₃, SbCl₅, FeCl₂, FeCl₃ and SnCl₄ give the best performance. Lewis protic acids can also be used as shown by the HCl example. Non-protic Lewis acids are preferred for cellulose and related substrates due to possible attack on the substrate by protic acids.

Three predominant applications of the Lewis acid effect are as follows:

1. Polymerisation of charge transfer complex (CT) in bulk

2. Grafting of CT to substrates like cellulose and the like including synthetics such as the polyolefins, polystyrene and the like

3. Curing of CT complexes.

Polymerisation in Bulk

The results in Table 1 show typical CT complexes and the UV dose required to gel with and without Lewis acid such as SbCl₃. A comparison with a typical PI like 1% Irgacure 819 is shown in the Table 1.

Polymerisation and Graft

Table 2 shows typical results for polymerisation when PI and SbCl₃ are combined in UV system. An enhancement in rate is noted when compared to the analogous system in Table 1. If a substrate such as cellulose is included in the CT solution, grafting occurs i.e. grafting is achieved at lower doses in the presence of SbCl₃.

Use of Ionising Radiation

Table 3 shows the effect of inclusion of Lewis acid when ionising radiation is used as source. Again in the presence of Lewis acid lower levels of radiation are needed to achieve gelling.

Curing

In the presence of Lewis acid the UV dose to cure CT complexes like MA/DVE-3 is reduced to at least one quarter. In some systems it is envisaged that the radiation dose may be able to be reduced by a factor of 10 or more. In many cases curing is too slow for commercial utilisation without the Lewis acid.

The important feature of the work with ionising radiation is that cobalt-60 can now be used as curing source because the doses to cure are so low e.g. 25 Gy in Table 3 with some CT complexes.

Any levels of Lewis acid can be theoretically used for this work, however, 1% w/w is a preferred economic level.

If radiation doses higher than shown in Table 3 with SbCl₃ are required to cure, that the system is less attractive for cobalt 60 work although with very large sources it may be possible although economically not generally attractive.

The present system is also suitable for electron beam (EB) cure with the doses shown in Table 3.

TABLE 1
Effect of SbCl₃ and Pl on Accelerating Polymerisation
of CT Complexes with UV Radiation

| Additives Used | UV Dose (J) | Physical State |
|---|---|---|
| MA/DVE-3 Complex | | |
| 1% Pl | 2.4 | Gel |
| No Additive | 132 | Gel |
| 1% SbCl₃ | Instantaneous* | Gel |
| MMA/DVE-3 Complex | | |
| 1% Pl | 108 | Viscous Gel |
| No Additive | 147 | Viscous Gel |
| 1% SbCl₃ | 108 | Viscous Gel |
| Ethyl Maleimide/DVE-3 Complex | | |
| 1% Pl | 19 | Off White Gel |
| No Additive | 108 | Off White Gel |
| 1% SbCl₃ | 37 | Off White Gel |
| Phenyl Maleimide/DVE-3 Complex | | |
| 1% Pl | 24 | Yellow Gel |
| No Additive | 254 | Liquid |
| 1% SbCl₃ | 60 | Yellow Gel |
| DMMA/DVE-3 Complex | | |
| No Additive | 54 | Clear Gel |
| 0.1% HCl (ION) | 31 | Clear Gel |

*On exposure to UV

Conditions of work reported for the above results:

Room Temperature maintained at 20° C.

UV lamp dose rate was 1.02×10⁻² Joules/Sec. Samples were positioned 30 cm from 90W medium pressure Hg arc lamps

Monomer complexes were prepared by mole ratio of 1:1

Irgacure 819 PI was used

Monomers used were prepared as 90% v/v in acetone

1% SbCl₃ was made up as a 1 M Acetone solution and was added at 10% v/v in acetone

TABLE 2
Additive Effects of Lewis Acid and Pl
On Accelerating UV Polymerisation of CT Complexes
Concurrent Grafting Yields on Cellulose (Whatman 41 Papers)

| Monomer | % | UV Dose | |
|---|---|---|---|
| Composition | Graft | (J)* | Physical State |
| MMA/DVE-3 + Pl + SbCl₃ | 10 | 24 | Highly Viscous |
| | | | Gel |
| MA/Vinyl Acetate + Pl + | 466 | 10 | Yellow White Gel |
| SbCl₃ | | | |
| Mono-Butyl Maleate + Pl + | 234 | 5 | Gel |
| SbCl₃ | | | |
| Bis(2-Ethylhexyl)maleate + Pl + | 225 | 12 | Gel |
| SbCl₃ | | | |

*Dose to gel, samples removed just prior to gel

Conditions of Work reported for the above results:

Solutions prepared in acetone grafting with 10% v/v of PI+SbCl₃

Monomer concentrations prepared were 90% v/v

Mole ratio used was 1:1

Room Temperature 22° C.

1% of Irgacure 819 PI

1M solutions of SbCl₃ prepared in acetone and used neat solvent

The 10% v/v used was composed of 5% of the PI and 5% of the 1 M SbCl₃ in acetone

Dose rate 1.02×10.2 Joules/sec.; Samples were positioned 30 cm from 90W medium pressure Hg arc lamp

TABLE 3
Effect of Lewis Acid on Accelerating Polymerisation of
CT Complexes Initiated by Ionising Radiation

| | | Irradiation | |
|---|---|---|---|
| Complex | SbCl₃* | Dose (Gy) | Observation |
| 1) 90% MA/DVE-3 1:1 in | NIL | 763 | Light Gel |
| Acetone 10% | | | |
| 2) 90% MA/DVE-3 1:1 in | 1% | 254 | Gel, Cracking |
| 10% Acetone | | | |
| 3) DMMA/DVE-3 1:1 | 1% | 254 | Gel |
| 4) 97% MA/DVE-3 1:1 in | 1% | 25 | Gel |
| Acetone 3% | | | |
| 5) 90% MA/DVE-3 1:1 | 1% | 25 | Gel |
| with 10% VA | | | |

*SbCl₃ molar in Acetone
**All complexes 1:1 molar,
Dose Rate = 7.63 kGy/hr in Cobolt-60 source
***Samples 3, 4, 5 without SbCl₃ required doses at least four times that of samples with SbCl₃
MA = Maleic anhydride
DVE-3 = Triethyleneglycol divinyl ether
DMMAS = Dimethyl maleate
VA = Vinyl acetate

The present invention is particularly suited to use in pigmented coatings. For example, in the pigmented compositions disclosed in the following examples, rate of curing may be enhanced by including in the preferred range of from 0.01 to 0.1 moles of Lewis acid per mole of double bonds in the charge transfer complex.

Pigmentation of the Above Resins

For the production of inks and coatings such as for curing as films the above resin systems will contain pigments or filler or both. For inks the level of pigments/filler will not necessarily be the same as for paints. Inks are essentially pastes to be applied by presses and the like whereas paints are of lower viscosity and are applied by spray, roller coat, curtain coat, volume coat and the like.

Inks

The level of PI needed in conventional UV inks using acrylate and related technology is shown in Table 4. These are typical of the amounts needed using current UV lamps.

TABLE 4
Levels of Pl Needed to Cure Conventional UV Inks*

| | Pigment | Pl |
|---|---|---|
| Colour | Loading to Cover (%) | (% W/W Total Ink) |
| Black | 20 | 10 |
| Blue | 15 | 10 |
| Red | 18 | 10 |
| Yellow | 12 | 10 |
| White | 50 | 4 |

*On a 200 Watt/inch mercury arc lamp line running at 20 metres/min

The PI's are generally mixtures to optimise performance. For example, in black there may be 3% Irgacure 369 and 7% Irgacure 651. The values in Table 4 are approximate and will depend on mixtures of PI's Within the ink systems themselves there is variation in the level of pigmentation used and therefore concentration of PI will be pro rata, depending on the pigment and the type of system. Thus lithographic inks use 10-30% of pigment (about 20% most common), flexographic 8-20% (12-14% most common), gravure 8-10% (8-10% most common), screen 5-15% most common and letterpress 18-20% most common.

When UV is used with the resin systems of the invention, typical photoinitiator levels, which may be needed to cure without the presence of Lewis acids are described in Table 5. Under some circumstances, white pigment with 600 Watts/inch excimer source, no PI is needed in the ink to achieve cure at line speeds of up to 10 metres/min. and higher.

Thus the advantages of using the new resin system are that under certain pigmentation conditions, no PI is needed to cure and where PI is needed the amount of PI is significantly lower than in conventional UV systems currently used. In the presence of appropriate Lewis acids, these levels of PI can be reduced even further. In some systems, it is envisaged that the amount of PI may be able to be reduced by a factor of 10 or more. In those systems where no PI is needed without Lewis acid, the presence of Lewis acid leads to shorter processing times.

TABLE 5
PIGMENTED POLYMERS
Photoinitiator Levels for Inks for
Polymer Systems without Lewis Acid

Preferred
Range Pl %

White (50%)

| | |
|---|---|
| White: (MA:DVE-3)(1:1) by weight* | 0.0-1.5 |
| White: (MA:DVE-3)(1:1) + 50% 1312 w/w | 0.0-1.0 |
| White: (MA:DVE-3)(1:1) + 25% 1312 | 0.0-1.3 |
| White: (MA:DVE-3):PE(2:1:1) | 0.0-0.3 |
| While (MA:DVE-3):PE(2:1:1) + 25% 1312 | 0.0-0.3 |

*50% White pigment with 50% resin consisting of MA:DVE-3
in ratio of 1:1 by weight.
Remaining pigment samples in same concept.

Blue (15%)

| | |
|---|---|
| Blue: (MA:DVE-3)(1:1) | 0.0-1.5 |
| Blue: (MA:DVE-3)(1:1) + 50% 1312 | 0.0-1.3 |
| Blue: (MA:DVE-3)(1:1) + 25% 1312 | 0.0-1.3 |
| Blue: (MA:DVE-3):PE(2:1:1) | 0.0-3.0 |
| Blue: (MA:DVE-3):PE(2:1:1) + 25% 1312 | 0.0-3.0 |

Red (18%)

| | |
|---|---|
| Red: (MA:DVE-3)(1:1) | 0.0-3.0 |
| Red: (MA:DVE-3)(1:1) + 50% 1312 | 0.0-1.5 |
| Red: (MA:DVE-3)(1:1) + 25% 1312 | 0.0-1.5 |
| Red: (MA:DVE-3):PE(2:1:1) | 0.0-2.0 |
| Red: (MA:DVE-3):PE(2:1:1) + 25% 1312 | 0.0-1.5 |

Black (20%)

| | |
|---|---|
| Black: (MA:DVE-3)(1:1) | 0.0-3.0 |
| Black: (MA:DVE-3)(1:1) + 50% 1312 | 0.0-6.0 |
| Black: (MA:DVE-3)(1:1) + 25% 1312 | 0.0-6.0 |
| Black: (MA:DVE-3):PE(2:1:1) | 0.0-6.0 |
| Black: (MA:DVE-3):PE(2:1:1) + 25% 1312 | 0.0-6.0 |

20% (18 Black:2 Blue)

| | |
|---|---|
| Blk/Blu: (MA:DVE-3)(1:1) | 0.0-6.0 |
| Blk/Blu: (MA:DVE-3)(1:1) + 50% 1312 | 0.0-6.0 |
| Blk/Blu: (MA:DVE-3)(1:1) + 25% 1312 | 0.0-6.0 |
| Blk/Blu: (MA:DVE-3):PE(2:1:1) | 0.0-6.0 |
| Blk/Blu: (MA:DVE-3):PE(2:1:1) + 25% 1312 | 0.0-6.0 |

Yellow (12%)

| | |
|---|---|
| Yellow: (MA:DVE-3)(3:1) | 0.0-6.0 |
| Yellow: (MA:DVE-3)(3:1) + 50% 1312 | 0.0-6.0 |
| Yellow: (MA:DVE-3)(3:1) + 25% 1312 | 0.0-6.0 |
| Yellow: (MA:DVE-3):PE(2:1:3) | 0.0-6.0 |
| Yellow: (MA:DVE-3):PE(2:1:3) + 25% 1312 | 0.0-6.0 |

HYBRIDS WITH URETHANE ACRYLATE
#(20% UR240)

| | |
|---|---|
| 18% Red + 82% (MA:DVE-3):PE(1:1:2)* | 0.0-3.6 |
| 20% Black + 80% (MA:DVE-3)PE(1:12) | 0.0-6.0 |
| 20% Blk/Blu + 80% (MA:DVE-3):PE(1:1:2) | 0.0-6.0 |
| 12% Yellow + 88% (MA:DVE-3):PE(1:1:2) | 0.0-6.0 |
| 15% Blue + 85% (MA:DVE-3):PE(1:1:2) | 0.0-4.0 |
| 50% White + 50% (MA:DVE-3):PE(1:1:2) | 0.0-2.0 |

*18% Red pigment by weight with 82% resin consisting of
MA:DVE-3:PE in ratios by weight of 1:1:2.
Same concept for other pigments
#UR240 is a aromatic urethane acrylate from Tollchem and 20% ww
of the total composition is added.
*Runs performed with 200 watt/inch mercury are lamp running at
20 metres/min

Paints

The level of pigmentation for paints varies with the type of paint and its application. UV has not previously been used with one-coat paints since PI's were not available to achieve cure. For paints very lightly pigmented, such as lime wash and the like, pigmentation levels used are of the order of 0.1% and a little higher by weight of paints. In Table 6 are shown typical pigment levels of conventional water based and solvent based gloss enamel paints with their PVC ratio.

TABLE 6
Pigment Levels for Conventional Interior/Exterior Gloss Enamels
(Water based, Solvent)

| Colour | % Weight | P.V.C |
|---|---|---|
| Red | 11 (9-13) | 15.8 |
| Black | 3.8 | 4.0 |
| Yellow | 9.0 | 12.0 |
| Blue | 9.0 | 8.7 |

When UV is used to cure the paints, the level of PI which may be needed to cure the paint is described in Table 7. Under some circumstances e.g. white pigment with 600 Watts/inch excimer source, no PI is needed in the paint to achieve cure at line speeds up to 10 metres/min. With lines of lower performance PI's may be needed as described above for the inks. The data in Table 7 do not include Lewis acids. Inclusion of Lewis acid as discussed above, significantly reduces the amount of PI required. In some systems, this may reduce the amount of PI required to a factor of 10 or more.

TABLE 7
PIGMENTED POLYMERS
Photoinitiator Levels for Paint without Lewis Acid

| | |
|---|---|
| | Preferred |
| PIGMENT LEVELS | Range Pl % |

GLOSS PAINT

| | |
|---|---|
| 11% Red + 89% (MA:DVE-3):PE (1:1:2) | 0.0-2.0 |
| 3.8% Black + 96.2% (MA:DVE-3):PE (1:1:2) | 0.0-4.5 |
| 9% Yellow + 91% (MA:DVE-3)PE (1:1:2) | 0.0-4.5 |
| 10% White + 90% (MA:DVE-3):PE (1:1:2) | 0.0-3.0 |
| 9% Blue + 91% (MA:DVE-3):PE (1:1:2) | 0.0-1.5 |

11% Red + 89% resin consisting of MA:DVE-3:PE 1:1:2 by weight
Remaining pigments same formula

GLOSS PAINT + 20% UR240*

| | |
|---|---|
| 11% Red + 89% (MA:DVE-3):PE (1:1:2) | 0.0-2.0 |
| 3.8% Black + 96.2% (MA:DVE-3):PE (1:1:2) | 0.0-4.5 |
| 3.8% Blk/Blu + 96.2% (MA:DVE-3):PE (1:1:2) | 0.0-4.0 |
| 9% Yellow + 91% (MA:DVE-3):PE (1:1:2) | 0.0-4.0 |
| 9% Blue + 91% (MA:DVE-3):PE (1:1:2) | 0.0-3.0 |

Paint formulations are 80% as per formula + 20% UR240 Resin

MATT PAINT
GLOSS PAINT + 20% Filler for matt finish

| | |
|---|---|
| 11% Red + 89% (MA:Dve-3):PE (1:1:2) | 0.0-4.5 |
| 3.8% Black + 96.2% (MA:DVE-3):PE (1:1:2) | 0.0-4.5 |
| 3.8% Blk/Blu + 96.2% (MA:DVE-3):PE (1:1:2) | 0.0-4.5 |
| 9% Yellow + 91% (MA:DVE-3):PE (1:1:2) | 0.0-4.5 |
| 9% Blue + 91% (MA:DVE-3):PE (1:1:2) | 0.0-4.5 |

Paint formulations are 80% of “Gloss” + 20% Filler for matt finish
DVE-3 = Triethylene glycol divinyl ether
PE = Polyester from Nuplex P/L
UR240 = aromatic urethane from Ballina P/L
MA = Maleic anhydride
*Running Condition as in Table 5

Specific Applications

A specific application of the current finishes is relevant to porous substances particularly timber. Thus timber (and other substrates) can be preprinted with a spirit stain (such as supplied by Pylon Chemicals LTD.) then immediately overcoated with a radiation curable finish, either clear gloss or clear matt. Alternatively, the stain (Hickson, supplier) as a powder can be dissolved in the coating and radiation cured on to timber or substrate.

Typical formulation for treating western red cedar timber:

(i) Stain with Pylon Chemicals LTD Spirit Stain

(ii) Then coat with following formula either gloss or maft (coating can be performed any time after stain application.

High Gloss Coating

| | |
|---|---|
| DVE-3 | 20 g |
| DEMA | 10 g |
| PE | 15 g |
| Irgacure 819 | 0.5 g |

After coating, sample is cured under a 300 Watt/inch mercury arc lamp at 20 metres/min. If Fusion 300 Watt/inch lamp with “D” bulb or an excimer source of 600 Watts/inch is used, no PI is required to cure at 20 metres/min. Inclusion of Lewis acid (such as SbCl₃, 1% w/w) leads to no PI to cure at 20 metres/min with a 300 Watt/inch mercury arch lamp. Inclusion of the Lewis acid with the Excimer source leads to curing at significantly higher line speeds.

Maft Coating

| | |
|---|---|
| DVE-3 | 23 g |
| DEMA | 10 g |
| PE | 15 g |
| Silica | 2 g |
| Calcium Carbonate | 3 g |
| Irgacure 819 | 0.5 g |

And conditions to cure as for the gloss coating. Inclusion of Lewis acid (such as SbCl₃, 1% w/w) leads to no PI to cure at 20 metres/min with a 300 Watt/inch mercury arch lamp. Inclusion of the Lewis acid with the Excimer source leads to curing at significantly higher line speeds.

Other typical examples of clear coatings are listed below. The pigmentation formulation of these type coatings is shown in Tables 5 and 7 where MA is used as acceptor instead of DEMA shown in the following typical examples.

Roller Coat Clear Gloss with CT Complex

| | |
|---|---|
| DEMA | 10 g |
| DVE-3 | 8 g |
| PE | 15 g |

The above formulation will cure at room temperature on a typical substrate such as Western Red Cedar Timber with Fusion 600 Watts/inch excimer source delivering 5.0 W/cm² at line speed of 16 metres/min. Sources of lower UV performance may need photoinitiator (up to 5% or higher by weight of resin) such as Irgacure 819 or the like to cure at line speeds of up to 20 m/min. and above. Inclusion of Lewis Acid (such as 1% SbCl₃ w/w) has the same accelerating affect as described above for the high gloss and matt coatings.

Spray Coat Clear Gloss with CT Complex

| | |
|---|---|
| DEMA | 10 g |
| DVE-3 | 20 g |
| PE | 15 g |

DEMA is diethyl maleate, DVE-3 is triethylene glycol di-vinyl ether and PE is the polyester previously discussed. Again higher amounts of DVE-3 are needed to achieve spray viscosity. The above formulation will cure at room temperature after being sprayed with a gun operating at 30 p.s.i on a typical substrate such as Western Red Cedar timber using a Fusion 300 Watt/inch excimer source delivering 0.5J/cm² at a line speed of 16 m/min. with “D” bulbs. Sources of lower UV performance may need photoinitiator (up to 5% or higher, by weight of resin) such as Irgacure 819 or the like to cure a line speeds up to 20 m./min. and above. Inclusion of Lewis Acid has the same enhancing effect as that described above for the preceding examples.

Spray Coat Clear Mayt with CT Complex

| | |
|---|---|
| DEMA | 110 g |
| DVE-3 | 23 g |
| PE | 15 g |
| SILICA | 2 g (Matting agent de Gussa No. OK412 |
| CaCO3 | 3 g |

The above formulation will cure at room temperature after being sprayed with a gun operating at 30 p.s.i on a typical substrate such as Western Red Cedar timber using a Fusion 600 Watt/inch excimer source delivering 5 W/cm² at a line speed of 16 m/min. Sources of lower UV performance may need photoinitiator (up to 5% or higher, by weight of resin) such as Irgacure 819) or the like to cure a line speeds up to 20 metres/min. and above. With lines of lower efficiency i.e. lower lamp performance such as 200 Watts/inch mercury lamps and the like PI's may be needed, to the levels previously described in the invention. The higher figure in the Table would be with a 200 Watts/inch mercury arc at 20 metres/min. Inclusion of Lewis acid has the same enhancing effect as that described above for the preceding examples.

Roller Coat Clear Gloss Hybrid Between CT Complex and Acrylates

| | |
|---|---|
| DEMA | 20 g |
| MA (Maleic anhydride) | 20 g |
| DVE-3 | 30 g |
| PE | 30 g |
| EPOXY ACRYLATE | 20 g |
| TPGDA | 8 g |

The above formulation will cure at room temperature after being sprayed with a gun operating at 30 p.s.i on a typical substrate such as Western Red Cedar timber using a Fusion 600 Watt/inch excimer source as indicated in the first example of the Roller Coat Clear Gloss with CT Complex. Inclusion of Lewis acid has the same enhancing effect as that described above for the preceding examples.

The above formulations are typical resin systems which can be pigmented to give coatings and inks which cure under photoinitiator free UV conditions using sources such as the 600 Watt/inch Fusion lamp. With lamps of lower performance, photoinitiators may be needed such as Irgacure 819 and the like as previously discussed.

Application of Ionising Radiation Sources

The above examples listed for inks and paints have utilised UV and excimer sources with and without PI. If these sources are replaced by ionising radiation sources such as EB (low energy electron beam from ESI or RPC or the equivalent) or Cobalt-60 (or equivalent spent fuel element facility) the coating and inks can be cured without any PI being present. The technique is particularly useful with Co-60 type sources. Here, with the formulations like those for the stain treatment above, curing can be achieved at a dose of up to 0.2 kGy at any dose rate in air. Under nitrogen even lower doses may be used. Higher doses than 0.2 kGy may be used if needed under specific circumstances even up to 5 kGy. For all the formulations in this patent, both clear and pigmented, inks and coatings, can all be cured at doses up to 0.2 kGy at any dose rate without PI and at even lower doses with nitrogen atmosphere. Inclusion of PI leads to lower doses than 0.2 kGy to cure however the film is then contaminated with PI fragments. Under some circumstances and in some applications the presence of these impurities can be tolerated and curing in the presence of the PI can lower the radiation dose to cure to doses up to 0.1 kGy. Inclusion of Lewis acid in these ionising radiation runs leads to enhancement in cure even at very low dosage. For example, it is possible to achieve cure with dose levels lower than 0.01 kGy. Inclusion of PI can lower this dose even further.

Dual Cure System

A further development in the resin technology both in clear and pigmented form is the dual cure system. If a moisture cured urethane (ex Tolichem or Wattyl, Australia) is added to the resin formulations shown in the examples and Tables and the resulting resin UV cured, adhesion is improved and hardness of film and other physical properties are also improved. The improvement is especially evident one hour after curing and for longer times when the moisture cured urethane has fully polymerised. Both aliphatic and aromatic moisture cured resins can be used with and without solvent, preferably without solvent. Two pack urethanes with and without solvent can also be used, the two components preferably being premixed prior to application and curing.

The amount of moisture cured resin or two pack urethane used can be any percentage by weight with 5-30% preferred and 5-15% most preferred relevant to the weight of the remaining clear or pigmented resin.

It is to be understood that the invention described herein above is susceptible to variations, modifications and/or additions other than those specifically described and that the invention includes all such variations, modifications and/or additions, which fall within the spirit and scope of the above description.

1. A radiation polymerisable composition comprising:
(A) a donor/acceptor component for forming a charge transfer complex said component being selected from the group consisting of:
(i) a bifunctional compound having an electron donor group and an electron withdrawing group and a polymerisable unsaturated group;
(ii) a mixture of (a) at least one unsaturated compound having an electron donor group and a polymerisable unsaturated moiety; and (b) at least one unsaturated compound having an electron acceptor group and a polymerisable unsaturated group; and
(B) a Lewis acid.

2. A radiation polymerisable composition according to claim 1 wherein the Lewis acid is selected from the group consisting of hard Lewis acids (as categorized by the Pearson classification), borderline Lewis acids (as categorized as borderline by the Pearson classification) and mixtures thereof.

3. A radiation polymerisable composition according to claim 1 wherein the Lewis acid is selected from the group consisting of salts of magnesium, zinc, antimony and mixtures thereof.

4. A radiation polymerisable composition according to claim 1 wherein the Lewis acid is a halide salt of a Lewis acid selected from the group consisting of Sb³⁺, Sb⁵⁺, Zn²⁺, Fe²⁺, Fe³⁺, Sn²⁺, Sn⁴⁺, Cu²⁺, Mg²⁺, Mn²⁺, Co²⁺ and Co³⁺.

5. A radiation polymerisable composition according to claim 1 wherein the Lewis acid is a protic acid selected from the group consisting of hydrogen halides, sulphuric acid, sulphonic acids, phosphoric acids, phosphonic acids, nitric acid, carboxylic acids and mixtures thereof.

6. A radiation polymerisable composition according to claim 5 wherein the Lewis acid is selected from the group consisting of hydrogen halides, saturated and unsaturated carboxylic acids, saturated and unsaturated polycarboxylic acids and mixtures thereof.

7. A radiation polymerisable composition according to claim 6 wherein the Lewis acid is selected from the group consisting of HCl, C₁ to C₈ carboxylic acids which may optionally be branched straight chain saturated or unsaturated, polycarboxylic acids and para toluene sulphonic acid.

8. A radiation polymerisable composition according to claim 1 wherein the Lewis acid is present in a molar ratio of less than 0.5 mole per mole of double bonds in the charge transfer complex component.

9. A radiation polymerisable composition according to claim 8 wherein the molar ratio is in the range of from 0.0005 to 0.1 mole per mole of double bonds in the charge transfer complex.

10. A radiation polymerisable composition according to claim 8 wherein the molar ratio is in the range of from 0.005 to 0.05 mole of Lewis acid per mole of double bonds in the charge transfer complex.

11. A radiation polymerisable composition according to claim 1 wherein the charge transfer complex is formed from
(a) at least one unsaturated compound having an electron acceptor group and a polymerisable unsaturated moiety and represented by the formula (A)ₙR wherein R is the structural part of the backbone and A is the structural fragment importing acceptor properties to the double bond and is selected from the group consisting of maleic diesters, maleic amide half esters, maleic diamides maleimides; and
(b) at least one unsaturated compound having an electron donor group and a polymerisable unsaturated moiety being represented by the formula (D)ₙR wherein R is the structural part of the backbone and D is the structural fragment importing donor properties to the double bond and is selected from the group consisting of vinyl ethers, alkenyl ethers, substituted cyclopentanes, substituted cyclohexanes, substituted furanes or thiophens, substituted pyrans and thiopyrans, ring substituted styrenes, substituted alkenyl benzenes, substituted alkenyl cyclopentanes and cyclohexenes.

12. A polymerisable composition according to claim 1 wherein in the charge transfer complex the acceptor component comprises maleic anhydride and the donor is selected from the group consisting of mono and divinyl ether and mixture thereof.

13. A radiation polymerisable composition according to claim 1 comprising an accepter selected from the group consisting of di-(C₁-C₂) alkyl ester of maleic acid and a donor selected from the group consisting of mono and divinyl ethers.

14. A radiation polymerisable composition according to claim 1 wherein the donor acceptor complex comprises vinyl ether or malonate capped urethane oligomer or mixture thereof.

15. A radiation polymerisable composition according to claim 1 further comprising a binder polymer.

16. A process for forming a coating on a substrate comprising providing a coating composition comprising:
(A) a donor/acceptor component for forming a charge transfer complex said component being selected from the group consisting of:
(i) a bifunctional compound having an electron donor group and an electron withdrawing group and a polymerisable unsaturated group;
(ii) a mixture of (a) at least one unsaturated compound having an electron donor group and a polymerisable unsaturated moiety; and (b) at least one unsaturated compound having an electron acceptor group and a polymerisable unsaturated group; and
(B) a Lewis acid;
applying a coating of the composition to the substrate and subjecting the coating to radiation for sufficient time to cure the coating.
